(19) United States
(12) Patent Application Publication
(10) Pub. No.: US 2025/0200839 A1
(43) Pub. Date: Jun. 19, 2025

(54) METHOD FOR IMAGE GENERATION USING WAVELET DIFFUSION SCHEME

(71) Applicant: VINAI ARTIFICIAL INTELLIGENCE APPLICATION AND RESEARCH JOINT STOCK COMPANY, Ha Noi (VN)

(72) Inventors: Hai Hung Bui, Ha Noi (VN); Tien Hao Phung, Ha Noi (VN); Minh Quan Dao, Ha Noi (VN); Tuan Anh Tran, Ha Noi (VN)

(21) Appl. No.: 18/538,122

(22) Filed: Dec. 13, 2023

(51) Int. Cl. G06T 11/00

(52) U.S. Cl. CPC G06T 11/006

(57) ABSTRACT

A method for image generation via backward diffusion of an image uses a wavelet-based diffusion scheme that performs backward diffusion on wavelet space instead of pixel space. At each step t, an output sample yₜ₋₁ is generated by a network p_{θ}(yₜ₋₁|yₜ) with parameters θ. After obtaining the clean sample y₀ through T steps, it is used to reconstruct the final image via inverse wavelet transformation (IWT). A wavelet-embedded generator receives wavelet subbands of shape [12×H×W] at timestep t, which are processed by a sequence of the proposed components. The outputs of the generator are the approximation of unperturbed inputs.

### BACKGROUND OF THE INVENTION

### 1. Field of the Invention

Embodiments of the invention relate generally to a techniques for image generation and more particularly to such a technique for image generation which uses a wavelet-based diffusion scheme.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Diffusion models are rising as a powerful solution for high-fidelity image generation, which exceeds GANs in quality in many circumstances. However, their slow training and inference speed is a huge bottleneck, blocking them from being used in real-time applications. A recent DiffusionGAN method significantly decreases the models' running time by reducing the number of sampling steps from thousands to several, but their speeds still largely lag behind the GAN counterparts.

Despite being introduced recently, diffusion models have grown tremendously and drawn many research interests. Such models revert the diffusion process to generate clean, high-quality outputs from random noise inputs. These techniques are applied in various data domains and applications but show the most remarkable success in image-generation tasks. Diffusion models can beat the state-of-the-art generative adversarial networks (GANs) in generation quality on various datasets. More notably, diffusion models provide a better mode coverage and a flexible way to handle different types of conditional inputs such as semantic maps, text, representations, and images. Thanks to this capability, they offer various applications such as text-to-image generation, image-to-image translation, image inpainting, image restoration, and more. Recent diffusion-based text-to-image generative models allow users to generate unbelievably realistic images just by text inputs, opening a new era of artificial intelligence (AI)-based digital art and promising applications to various other domains. While showing great potential, diffusion models have a very slow running speed, a critical weakness blocking them from being widely adopted like GANs. The foundation work Denoising Diffusion Probabilistic Models (DDPMs) requires a thousand sampling steps to produce the desired output quality, taking minutes to generate a single image. Many techniques have been proposed to reduce the inference time, mainly via reducing the sampling steps. However, the fastest algorithm before DiffusionGAN still takes seconds to produce a 32×32 image, which is about 100 times slower than GAN. DiffusionGAN made a break-through in fastening inference speed by combining Diffusion and GANs in a single system, which ultimately reduces the sampling steps to 4 and the inference time to generate a 32×32 image as a fraction of a second. It makes DiffusionGAN the fastest existing diffusion model. Still, it is at least 4 times slower than the StyleGAN counterpart, and the speed gap consistently grows when increasing the output resolution. Moreover, DiffusionGAN still requires a long training time and a slow convergence, confirming that diffusion models are not yet ready for large-scale or real-time applications.

### SUMMARY OF THE INVENTION

It is therefore an object of the invention to realize a more efficient image generation algorithm based on wavelet-based diffusion scheme to obtain a clean sample from an image having pure Gaussian noise. Another object of the invention is to bridge the speed gap by introducing a novel wavelet-based diffusion scheme. The solution of the invention relies on discrete wavelet transform, which decomposes each input image into four sub-bands for low (LL) and high-frequency (LH, HL, HH) components. The solution further uses that transform on both image and feature levels. This allows the solution of the invention to significantly reduce both training and inference times while keeping the output quality relatively unchanged. On the image level, the invention obtains a high speed boost by reducing the spatial resolution four times. On the feature level, the invention stresses the importance of wavelet information on different blocks of the generator. With such a design, the invention on the feature level can obtain considerable performance improvement while inducing only a marginal computing overhead.

The proposed wavelet diffusion solution provides state-of-the-art training and inference speed while maintaining high generative quality, thoroughly confirmed via experiments on standard benchmarks including CIFAR-10, STL-10, CelebA-HQ, and LSUN-Church. The invention significantly reduces the speed gap between diffusion models and GANs, targeting large-scale and real-time systems.

Embodiments of the present invention provide a method for image generation via backward diffusion from a random image comprising obtaining the random image; transforming the random image, using a wavelet transform, to decompose the obtained random image into four wavelet subbands to leverage high frequency information of the obtained random image for further increasing the details of a generated image for a backward diffusion process; in the backward diffusion process, starting from each timestep t=T down to t=1, gradually generating a less-corrupted sample yₜ₋₁ from the four wavelet subbands by using a network p_{θ}(yₜ₋₁|yₜ) with parameters θ; after obtaining the clean sample y₀ through T steps, concatenating four output wavelet subbands as a single target; and performing an inverse wavelet transform the single target to reconstruct an output image.

In some embodiments, which may be combined with the above embodiment, y₀ is a clean sample and yₜ is a corrupted sample at timestep t.

In some embodiments, which may be combined with one or more of the above embodiments, the network p_{θ}(yₜ₋₁|yₜ) with parameters θ is p_{θ}(y₍ₜ₋₁₎|yₜ)=N(y₍ₜ₋₁₎; μ_{θ}(yₜ, t), σₜ² I); and μ_{θ}(yₜ, t) and σₜ² are a mean and a variance of a parametric network model, respectively.

In some embodiments, which may be combined with one or more of the above embodiments, the wavelet transform is a Haar wavelet transform.

In some embodiments, which may be combined with one or more of the above embodiments, the network is modeled to incorporate information into a feature space through a generator to strengthen awareness of high-frequency components.

In some embodiments, which may be combined with one or more of the above embodiments, the network is modeled for M down-sampling and M up-sampling blocks, plus skip connections between blocks of a same resolution, where M is a predefined number.

In some embodiments, which may be combined with one or more of the above embodiments, the network is modeled using frequency-aware blocks in place of down-sampling and up-sampling operators.

In some embodiments, which may be combined with one or more of the above embodiments, the network is modeled using, at a lowest resolution, frequency-bottleneck blocks for attention on low and high-frequency components.

In some embodiments, which may be combined with one or more of the above embodiments, the network is modeled incorporating original signals Y to different feature pyramids of an encoder, introducing frequency residual connections using wavelet down-sample layers.

In some embodiments, which may be combined with one or more of the above embodiments, the method is performed by a system, the system comprising a processor; a data bus coupled to the processor; a memory coupled to the data bus; and a computer-usable medium embodying a computer program code, the computer program code comprising instructions executable by the processor and configured to perform the method according to any of the above embodiments.

Embodiments of the present invention provide a computer program product for image generation via backward diffusion from a random image, the computer program product comprising a computer readable storage medium having program instructions embodied therewith, the program instructions executable by a computer to cause the computer to obtain the random image; transform the random image, using a wavelet transform, to decompose the obtained random image into four wavelet subbands to leverage high frequency information of the obtained random image for further increasing the details of a generated image for a backward diffusion process; in the backward diffusion process, starting from each timestep t=T to t=1, gradually generate a less-corrupted sample yₜ₋₁ from the four wavelet subbands by using a network p_{θ}(yₜ₋₁|yₜ) with parameters θ; after obtaining the clean sample y₀ through T steps, concatenate four output wavelet subbands as a single target; and perform an inverse wavelet transform the single target to reconstruct an output image, wherein y₀ is a clean sample and yₜ is a corrupted sample at timestep t; the network p_{θ}(yₜ₋₁|yₜ) with parameters θ is p_{θ}(yₜ₋₁|yₜ)= [symbol] (yₜ₋₁; μ_{θ}(yₜ, t), σₜ² I); and μ_{θ}(yₜ, t) and σₜ² are a mean and a variance of a parametric network model, respectively.

In summary, the contributions of the invention to the art include the following. (1) provides a novel wavelet diffusion framework that takes advantage of the dimensional reduction of wavelet subbands to accelerate diffusion models while maintaining good visual quality of generated results through high-frequency components; (2) employs wavelet decomposition in both image and feature space to improve generative models' robustness and execution speed; and (3) provides state-of-the-art training and inference speed, which serves as a stepping-stone to facilitating real-time and high-fidelity diffusion models.

These and other features, aspects and advantages of the present invention will become better understood with reference to the following drawings, description, and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 shows a wavelet-based diffusion scheme that can perform a backward diffusion process on wavelet space instead of pixel space;

FIGS. 2A and 2B show the details of frequency-aware down-sampling and up-sampling blocks in the wavelet-embedded generator;

FIG. 3 shows the details of frequency down-sample block and frequency bottleneck block;

FIG. 4 shows the details of the wavelet-embedded generator, where, for simplification, timestep embedding t and latent embedding z are ignored but they are injected in individual blocks of the backward diffusion process, and the inputs are noisy wavelet subbands of shape [12×H×W] at timestep t, which are processed by a sequence of the proposed components, including frequency-aware up-sampling and down-sampling blocks, frequency residual connections, and a brand new frequency bottleneck block, where the outputs of the model are the approximation of unperturbed inputs;

FIG. 5 depicts the qualitative results of CIFAR-10 32×32;

FIG. 6 depicts the qualitative results of CelebA-HQ 256×256;

FIG. 7 depicts the qualitative results of CelebA-HQ 512×512;

FIG. 8A depicts training convergence comparisons;

FIG. 8B depicts generated samples;

FIG. 9 depicts the qualitative results of LSUN-Church 256×256; and

FIG. 10 depicts comparisons between the solution of the invention and other GAN and diffusion techniques in terms of FID and sampling time the on CIFAR-10 (32×32) dataset, where the solution of the invention is 2.5 times faster than DDGAN, the fastest up-to-date diffusion method, and approaches the real-time speed of StyleGAN methods while still achieving comparable FID scores.

The invention and its various embodiments can now be better understood by turning to the following detailed description wherein illustrated embodiments are described.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Python, Perl, UNIX Shell, Visual Basic or Visual Basic Script, Virtual Reality Markup Language (VRML), ColdFusion™ or other compilers, assemblers, interpreters or other computer languages or platforms.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G, 5G, or the like.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

Broadly, embodiments of the present invention provide a method for image generation via backward diffusion of an image by using a wavelet-based diffusion scheme that performs backward diffusion on wavelet space instead of pixel space. At each step t, an output sample yₜ₋₁ is generated by a network p_{θ}(yₜ₋₁|yₜ) with parameters θ. After obtaining the clean sample y₀ through T steps, it is used to reconstruct the final image via inverse wavelet transformation (IWT). A wavelet-embedded generator receives wavelet subbands of shape [12×H×W] at timestep t, which are processed by a sequence of the proposed components. The outputs of the generator are the approximation of unperturbed inputs.

For better understanding the techniques and solution in the proposed invention, some core state-of-the-art technologies should be reviewed.

### Diffusion Models

The traditional diffusion process requires thousand timesteps to gradually diffuse each input x₀, following a data distribution p(x₀), into pure Gaussian noise. The posterior probability of a diffused image xₜ at timestep t has a closed form:

$$q ( {x}_{t} \vert {x}_{0} ) = 𝒩 ( {x}_{t} ; \sqrt{{\overline{a}}_{t}} {x}_{0} , ( 1 - {\overline{a}}_{t} ) I ) \qquad ( 1 )$$

where αₜ=1−βBₜ, āₜ=Πₛ₌₁^{t}αₛ, and βt∈(0, 1) is defined to be small through a variance schedule which can be learnable or fixed at timestep t in the forward process. Since the diffusion process adds relatively small noise per step, the reverse process q(xₜ₋₁|xₜ) can be approximated by Gaussian process q(xₜ₋₁|xₜ, x₀). Therefore, the trained process p_{θ}(xₜ₋₁|xₜ) can be parameterized according to q(xₜ₋₁|xₜ, x₀). The common parameterized form of p_{θ}(xₜ₋₁|xₜ) is:

$${p}_{θ} ( {x}_{t - 1} \vert {x}_{t} ) = 𝒩 ( {x}_{t - 1} ; {μ}_{θ} ( {x}_{t} , t ) , {σ}_{t}^{2} I ) \qquad ( 2 )$$

Where μ_{θ}(xₜ, t) and σₜ² are the mean and variance of the parametric backward diffusion model, respectively. The objective is to minimize the distance between a true backward diffusion distribution q(xₜ₋₁|xₜ) and the parameterized one p_{θ}(xₜ₋₁|xₜ) through Kullback-Leibler (KL) divergence. Unlike the traditional diffusion methods, DiffusionGAN enables large step sizes for faster sampling through generative adversarial networks. It introduces a discriminator Dϕ and optimizes both the generator and the discriminator in an adversarial training manner:

$${min}_{ϕ} {max}_{θ} {\sum }_{t \geq 1} {𝔼}_{q ( {x}_{t} )} [ {𝔼}_{q ( {x}_{t - 1} \vert {x}_{t} )} [ - log ( {𝒟}_{ϕ} ( {x}_{t - 1} , {x}_{t} , t ) ) ] + {𝔼}_{{p}_{θ} ( {x}_{t - 1 \vert {x}_{t} )}} [ log ( {𝒟}_{ϕ} ( {x}_{t - 1} , {x}_{t} , t ) ) ] \qquad ( 3 )$$

where fake samples are sampled from a conditional generator p_{θ}(xₜ₋₁|xₜ). As large step sizes cause q(xₜ₋₁|xₜ) to be no longer a Gaussian distribution, DiffusionGAN aims to implicitly modelize this complex multimodal distribution with a generator G_{θ}(xₜ, z,t) given a D-dimensional latent variable z˜ [symbol] (0, I). Specifically, DiffusionGAN first generates unperturbed sample x₀′ (through the generator G_{θ}(xₜ, z, t) and acquires the corresponding perturbed sample xₜ₋₁′ using q(xₜ₋₁|xₜ, x₀). Meanwhile, the discriminator performs judgment on real pairs [symbol] _{ϕ}(xₜ₋₁, xₜ, t) and fake pairs [symbol] _{ϕ}(xₜ₋₁′, xₜ, t). For convenience, DiffusionGAN will be abbreviated as DDGAN in later parts.

### Wavelet Transform

Wavelet Transform is a classical technique widely used in image compression to separate the low-frequency approximation and the high-frequency details from the original image. While low subbands are similar to down-sampled versions of the original image, high subbands express the local statistics of vertical, horizontal, and diagonal edges. Notably, the Haar wavelet is widely adopted in real-world applications due to its simplicity. It involves two types of operations: discrete wavelet transform (DWT) and discrete inverse wavelet transform (IWT).

Let denote

$$L = \frac{1}{\sqrt{2}} [ \begin{matrix}1 & 1\end{matrix} ] and H = \frac{1}{\sqrt{2}} [ \begin{matrix}- 1 & 1\end{matrix} ]$$

be low-pass and high-pass filters. They are used for constructing four kernels with stride 2, namely LLT, LHT, HLT, and HHT to decompose the input X∈RH×W into four subbands Xll, Xlh, Xhl, and Xhh with a size of H/2×W/2. As these filters are pairwise orthogonal, they can form a 4×4 invertible matrix to accurately reconstruct original signals X from frequency components by IWT. In the present invention, this kind of transform is used to decompose input images and feature maps to emphasize high-frequency components and reduce the spatial dimensions to four folds for more efficient sampling.

This section describes the wavelet diffusion framework according to embodiments of the present invention. First, the core wavelet-based diffusion scheme for more efficient sampling is presented. Then, the design of a new wavelet-embedded generator is depicted for better frequency-aware image generation.

### Wavelet-Based Diffusion Scheme

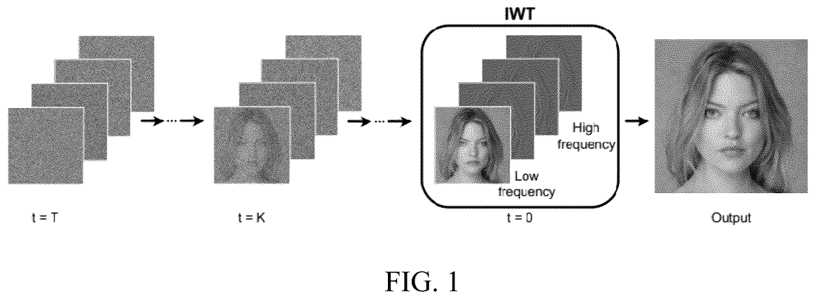

Firstly, the incorporation of wavelet transform in the diffusion process is described in more detail. A random input image (also referred to as a random noisy input image or noisy image), typically having Gaussian noise, is decomposed into four wavelet subbands and these subbands are concatenated as a single target for the backward diffusion process as illustrated in FIG. 1. Such a model does not perform on the original image space but on the wavelet spectrum. As a result, the model can leverage high-frequency information to increase the details of generated images further. Meanwhile, the spatial area of wavelet subbands is four times smaller than the original image, so the computational complexity of the sampling process is significantly reduced. The method is built upon DDGAN model, where the input is 4 wavelet subbands of wavelet transformation. Given input image x∈R3×H×W, the input image can be decomposed into a set of low and high subbands which are further concatenated to form a matrix y∈R12× H2×W2. This input is then projected to the base channel D via the first linear layer, keeping the network width unchanged compared with DDGAN. Hence, most of the network benefits from 4 times reduction in spatial dimensions, significantly reducing its computation.

Let denote y₀ be a clean sample and yₜ be a corrupted sample at timestep t which is sampled from q(yₜ|y₀). In terms of the backward diffusion process, a generator receives a tuple of variable yₜ, a latent z˜ [symbol] (0, I), and a timestep t to generate an approximation of original signals y₀: y₀′=G (yₜ,z,t). The predicted output sample yₜ₋₁′ is then drawn from tractable posterior distribution q(yₜ₋₁|yₜ, y₀′). The role of the discriminator is to distinguish the real pairs (yₜ₋₁, yₜ) and the fake pairs (yₜ₋₁′,yₜ).

### Adversarial Objective

The generator and the discriminator are optimized through the adversarial loss:

$${ℒ}_{a d v}^{D} = - log ( D ( {y}_{t - 1} , {y}_{t} , t ) ) + log ( D ( {y}_{t - 1}^{′} , {y}_{t} , t ) ) , {ℒ}_{a d v}^{D} = - log ( D ( {y}_{t - 1}^{′} , {y}_{t} , t ) ) \qquad ( 4 )$$

### Reconstruction Term

In addition to the adversarial objective in Equation (4), a reconstruction term is added to not only impede the loss of frequency information but also preserve the consistency of wavelet subbands. It is formulated as an L1 loss between a generated image and its ground-truth:

$${ℒ}_{r e c} = ‖ {y}_{0}^{′} - {y}_{0} ‖ . \qquad ( 5 )$$

The overall objective of the generator is a linear combination of adversarial loss and reconstruction loss:

$${ℒ}^{G} = {ℒ}_{a d v}^{G} + {λℒ}_{rec} , \qquad ( 6 )$$

where λ is a weighting hyper-parameter (default value is 1). After a few sampling steps as defined, the estimated cleaned subbands y₀′ is acquired. The final image can be recovered via wavelet inverse transformation xₒ′=IWT (y₀′).

The sampling process is depicted in Algorithm 1.

Algorithm 1 Wavelet-based sampling process

```
yₜ ~ [symbol]    (0, I)
for t = T, . . . , 1 do
  z ~ [symbol]    (0, I)
  y′₀ = G(yₜ, z, t)
  yₜ₋₁ ~ q(yₜ₋₁|yₜ, y′₀)
end for
x₀ = IWT(y₀)
return x₀
```

### Wavelet-Embedded Networks

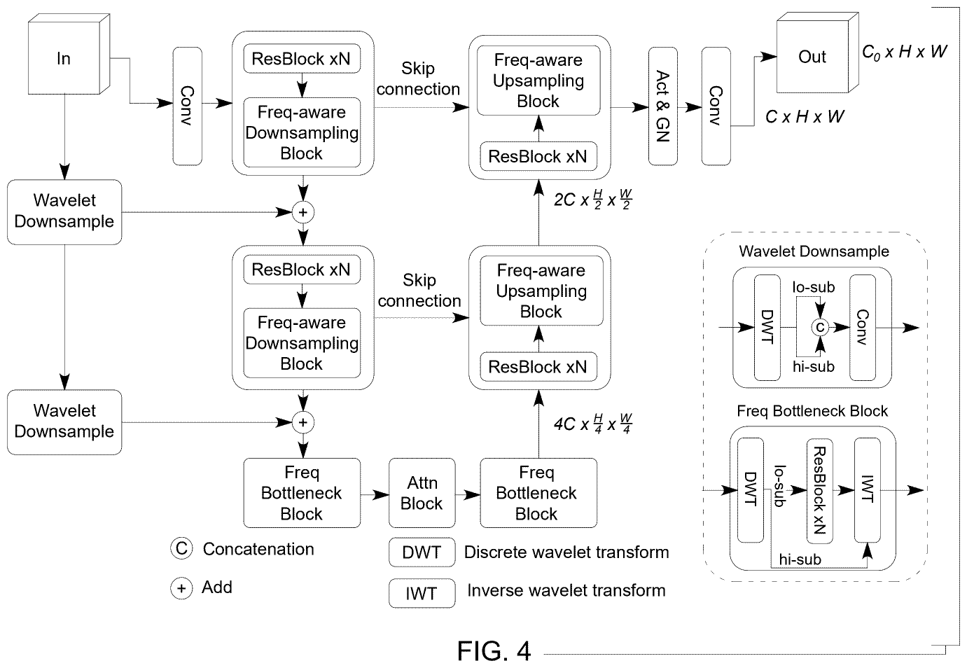

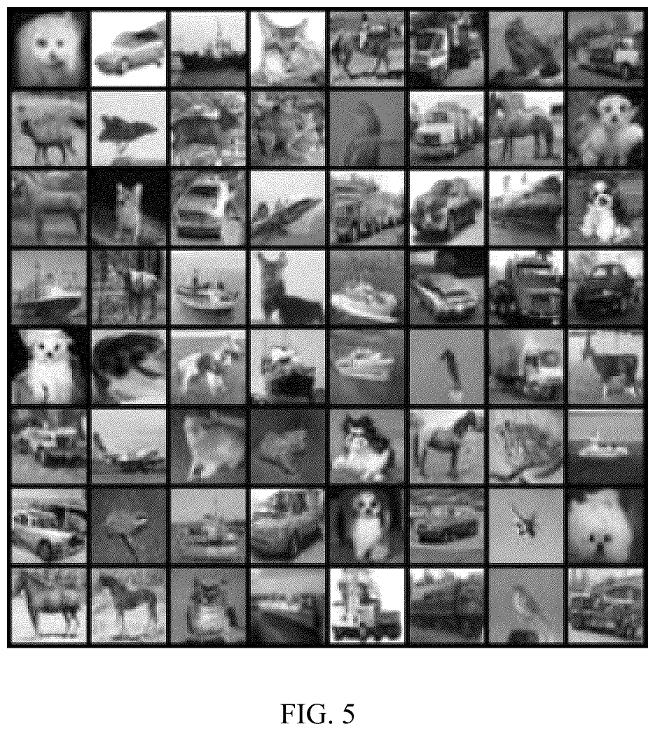

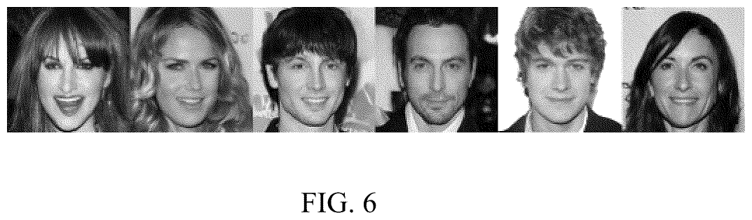

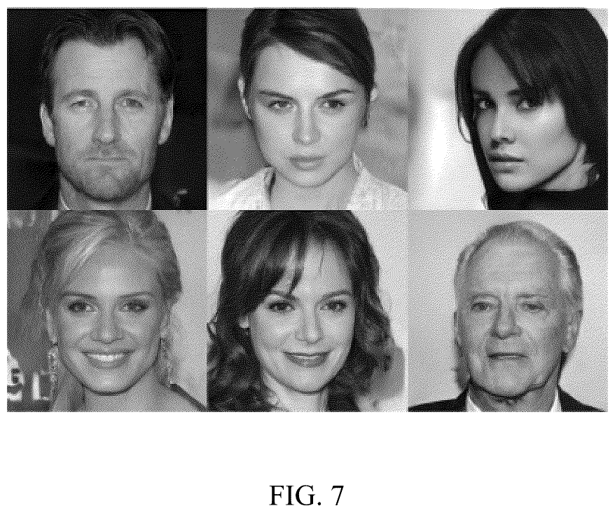

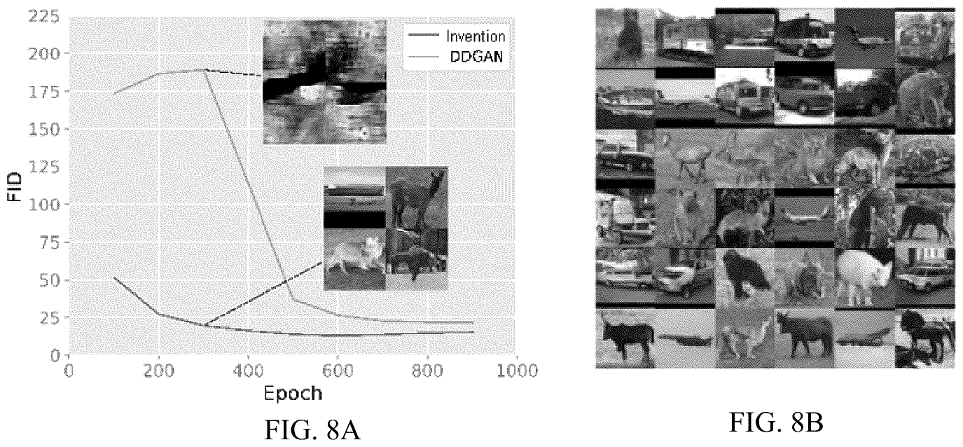

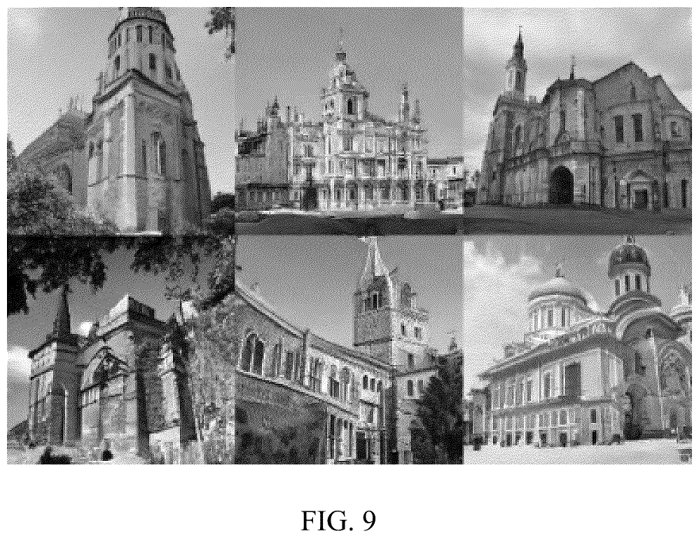

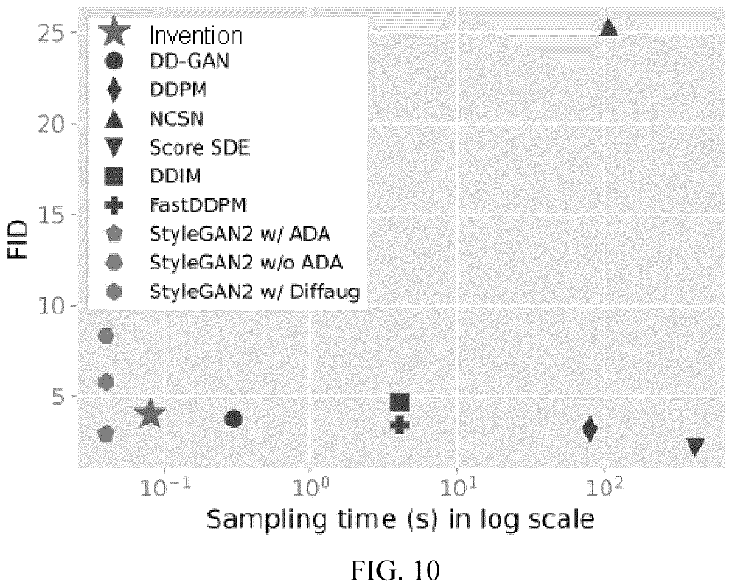

FIG. 4 is an illustration of the wavelet-embedded generator. For simplification, timestep embedding t and latent embedding z are ignored but they are injected in individual blocks of the backward diffusion process. The inputs are noisy wavelet subbands of shape [12×H×W] at timestep t, which are processed by a sequence of the proposed components, including frequency-aware up-sampling and down-sampling blocks, frequency residual connections, and a brand new frequency bottleneck block. The outputs of the model are the approximation of unperturbed inputs.

Next, the wavelet information is incorporated into feature space through the generator to strengthen the awareness of high-frequency components. This is beneficial to the sharpness and quality of final images.

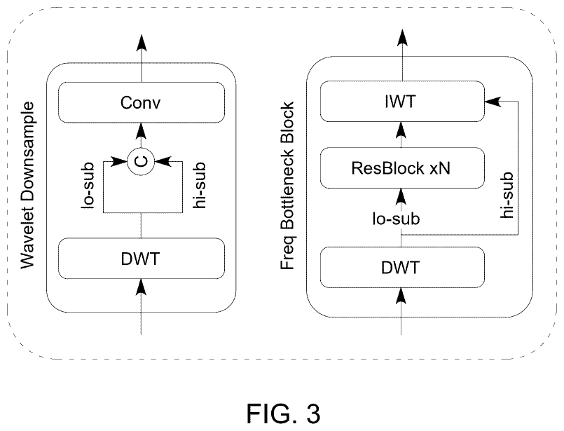

FIG. 3 illustrates the structure of our proposed wavelet embedded generator. It follows the UNet structure with M down-sampling and M up-sampling blocks plus skip connections between blocks of the same resolution, with M predefined. However, instead of using the normal down-sampling and up-sampling operators, frequency-aware blocks are used. At the lowest resolution, frequency-bottleneck blocks are employed for better attention on low and high-frequency components. Finally, to incorporate original signals Y to different feature pyramids of the encoder, frequency residual connections are introduced using wavelet down-sample layers. Let denote Y be the input image and Fi is the i-th intermediate feature map of Y.

### Frequency-Aware Down-Sampling and Up-Sampling Blocks

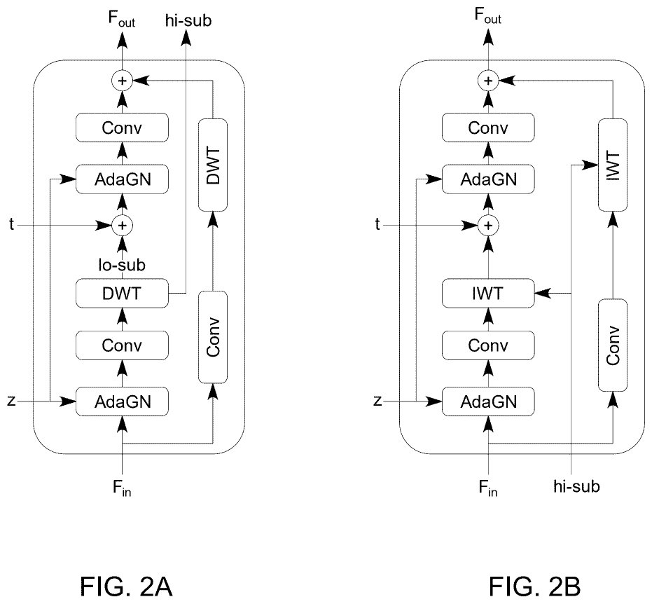

Traditional approaches relied on a blurring kernel for the down-sampling and up-sampling process to mitigate the aliasing artifact. The inherent properties of the wavelet transform are utilized for better up-sampling and down-sampling (depicted in FIG. 2). This, in fact, strengthens the awareness of high-frequency information on these operations. Particularly, the down-sampling block receives a tuple of input features Fi, a latent z, and time embedding t, which are then processed through a sequence of layers to return down-sampled features and high-frequency subbands. These returned subbands are served as an additional input to up-sample features based on frequency cues in the up-sampling block.

The frequency bottleneck block locates at the middle stage, which includes two frequency bottleneck blocks and one attention block in-between. Each frequency bottleneck block first divides feature map Fᵢ into the low-frequency subband F_{i,ll} and the concatenation of high-frequency subbands F_{i,H}. F_{i,ll} is then passed as input to resnet block(s) for deeper processing. The processed low-frequency feature map and the original high-frequency subbands F_{i,H} are transformed back to the original space via IWT. With such a bottleneck, the model can focus on learning intermediate feature representations of low-frequency subbands while preserving the high-frequency details.

### Frequency Residual Connection

The use of a wavelet down-sample layer is to map residual shortcuts of input Y to the corresponding feature dimensions, which are then added to each feature pyramid. Specifically, the residual shortcuts of Y are decomposed into four subbands which are then concatenated and fed to a convolution layer for feature projection. This shortcut aims to enrich the perception of the frequency source of feature embeddings.

As discussed above, computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the illustrative embodiments of the present invention provides a methodology, apparatus, system and computer program product for performing medical image dataset augmentation, or expansion, using a Wavelet Diffusion network framework or architecture. The illustrative embodiments adapt a Wavelet Diffusion mechanism to operate on image data, and generate a corresponding clear image by a generator G of the Wavelet Diffusion mechanism.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method for image generation via backward diffusion from a random image, the method comprising:
obtaining the random image;
transforming the random image, using a wavelet transform, to decompose the obtained random image into four wavelet subbands to leverage high frequency information of the obtained random image for further increasing the details of a generated image for a backward diffusion process;
in the backward diffusion process, starting from each timestep t=T down to t=1, gradually generating a less-corrupted sample yₜ₋₁ from the four wavelet subbands by using a network p_{θ}(yₜ₋₁|yₜ) with parameters θ;
after obtaining the clean sample y₀ through T steps, concatenating four output wavelet subbands as a single target; and
performing an inverse wavelet transform the single target to reconstruct an output image.

2. The method of claim 1, wherein y₀ is a clean sample and yₜ is a corrupted sample at timestep t.

3. The method of claim 1, wherein:
the network p_{θ}(yₜ₋₁|yₜ) with parameters θ is p_{θ}(yₜ₋₁|yₜ)= [symbol] (yₜ₋₁; μ_{θ}(yₜ, t), σₜ² I); and
μ_{θ}(yₜ, t) and σₜ² are a mean and a variance of a parametric network model, respectively.

4. The method of claim 1, wherein the wavelet transform is a Haar wavelet transform.

5. The method of claim 1, wherein the network is modeled to incorporate information into a feature space through a generator to strengthen awareness of high-frequency components.

6. The method of claim 1, wherein the network is modeled for M down-sampling and M up-sampling blocks, plus skip connections between blocks of a same resolution, where M is a predefined number.

7. The method of claim 1, wherein the network is modeled using frequency-aware blocks in place of down-sampling and up-sampling operators.

8. The method of claim 1, wherein the network is modeled using, at a lowest resolution, frequency-bottleneck blocks for attention on low and high-frequency components.

9. The method of claim 1, wherein the network is modeled incorporating original signals Y to different feature pyramids of an encoder, introducing frequency residual connections using wavelet down-sample layers.

10. A system comprising:
a processor;
a data bus coupled to the processor;
a memory coupled to the data bus; and
a computer-usable medium embodying a computer program code, the computer program code comprising instructions executable by the processor and configured to:
obtain a random image;
transform the random image, using a wavelet transform, to decompose the obtained random image into four wavelet subbands to leverage high frequency information of the obtained random image for further increasing the details of a generated image for a backward diffusion process;
in the backward diffusion process, starting from each timestep t=T to t=1, gradually generate a less-corrupted sample yₜ₋₁ from the four wavelet subbands by using a network p_{θ}(yₜ₋₁|yₜ) with parameters θ;
after obtaining the clean sample y₀ through T steps, concatenate four output wavelet subbands as a single target; and
perform an inverse wavelet transform the single target to reconstruct an output image.

11. The system of claim 10, wherein:
y₀ is a clean sample and yₜ is a corrupted sample at timestep t;
the network p_{θ}(yₜ₋₁|yₜ) with parameters θ is p_{θ}(yₜ₋₁|yₜ)= [symbol] (yₜ₋₁; μ_{θ}(yₜ,t), σₜ² I); and
μ_{θ}(yₜ, t) and σₜ² are a mean and a variance of a parametric network model, respectively.

12. The system of claim 10, wherein the wavelet transform is a Haar wavelet transform.

13. The system of claim 10, wherein the network is modeled to incorporate information into a feature space through a generator to strengthen awareness of high-frequency components.

14. The system of claim 10, wherein the network is modeled for M down-sampling and M up-sampling blocks, plus skip connections between blocks of a same resolution, where M is a predefined number.

15. The system of claim 10, wherein the network is modeled using frequency-aware blocks in place of down-sampling and up-sampling operators.

16. The system of claim 10, wherein the network is modeled using, at a lowest resolution, frequency-bottleneck blocks for attention on low and high-frequency components.

17. The system of claim 10, wherein the network is modeled incorporating original signals Y to different feature pyramids of an encoder, introducing frequency residual connections using wavelet down-sample layers.

18. A computer program product for image generation via backward diffusion from a random image, the computer program product comprising a computer readable storage medium having program instructions embodied therewith, the program instructions executable by a computer to cause the computer to:
obtain the random image;
transform the random image, using a wavelet transform, to decompose the obtained random image into four wavelet subbands to leverage high frequency information of the obtained random image for further increasing the details of a generated image for a backward diffusion process;
in the backward diffusion process, starting from each timestep t=T to t=1, gradually generate a less-corrupted sample yₜ₋₁ from the four wavelet subbands by using a network p_{θ}(yₜ₋₁|yₜ) with parameters θ;
after obtaining the clean sample y₀ through T steps, concatenate four output wavelet subbands as a single target; and
perform an inverse wavelet transform the single target to reconstruct an output image, wherein:
y₀ is a clean sample and yₜ is a corrupted sample at timestep t;
the network p_{θ}(yₜ₋₁|yₜ) with parameters θ is p_{θ}(yₜ₋₁|yₜ)= [symbol] (yₜ₋₁; μ_{θ}(yₜ, t), σₜ² I); and
μ_{θ}(yₜ, t) and σₜ² are a mean and a variance of a parametric network model, respectively.

19. The computer program product of claim 18, wherein the wavelet transform is a Haar wavelet transform.

20. The computer program product of claim 18, wherein instructions are configured to cause the computer to model the network for one or more of the following features:
to incorporate information into a feature space through a generator to strengthen awareness of high-frequency components;
for M down-sampling and M up-sampling blocks, plus skip connections between blocks of a same resolution, where M is a predefined number;
using frequency-aware blocks in place of down-sampling and up-sampling operators;
using, at a lowest resolution, frequency-bottleneck blocks for attention on low and high-frequency components; or
to incorporate original signals Y to different feature pyramids of an encoder, introducing frequency residual connections using wavelet down-sample layers.
